(19) United States
(12) Patent Application Publication
(10) Pub. No.: US 2022/0135306 A1
(43) Pub. Date: May 5, 2022

(54) PACKAGING FOR OUTGASSING AND/OR MATURING FOODS, IN PARTICULAR FOR ROASTED COFFEE AND/OR COFFEE BEANS

(71) Applicant: LANG LASER - SYSTEM GMBH, Ummendorf (DE)

(72) Inventors: Bernhard LANG, Ummendorf (DE); Christian LANG, Ummendorf (DE)

(73) Assignee: LANG LASER - SYSTEM GMBH, Ummendorf (DE)

(21) Appl. No.: 17/085,146

(22) Filed: Oct. 30, 2020

(51) Int. Cl. B65D 79/00; B65D 75/26; B65B 61/02; B65D 65/46; B32B 27/10; B32B 27/32; B32B 27/36

(52) U.S. Cl. CPC B65D 79/005; B65D 75/26; B65B 61/02; B65D 65/466; B32B 2439/70; B32B 27/32; B32B 27/36; B32B 2439/46; B32B 2307/7163; B32B 27/10

(57) ABSTRACT

The invention relates to a package for outgassing foods and/or maturing foods, in particular roasted coffee and/or coffee beans, comprising a bag for storing the food, which includes a film from which the bag is formed, wherein a valve is provided to enable a discharge of gas from the package bag to the outside in the event of overpressure in the package and to reduce the diffusion-related gas exchange in the case of comparable and/or equal pressure conditions in and/or outside the package bag. It is characterized in that the valve is formed as a microperforation in the film having at least one or two holes of the size of 750 μm² to 40 000 μm², preferably of 390 μm² to 20 000 μm², particularly preferably 70 μm² to 16 000 μm² and/or each having the diameter of 10-70 μm, preferably 20-60 μm, particularly preferably 30 μm.

### FIELD OF THE INVENTION

The present invention relates to a package for outgassing foods and/or maturing foods, in particular roasted coffee and/or coffee beans, as well as a corresponding production method.

### BACKGROUND OF THE INVENTION

Many foods are portioned and handled in packages for simpler handling and, in particular, for their protection. Chemical processes typically take place in these foods, during which, inter alia, gases also arise. However, some of these gases impair the quality, the ripening process, the consistency, and/or other properties of these foods.

A variety of such chemical reactions are set into gear within the bean, for example, during the roasting process of coffee beans, which ensure that the coffee can unfold its full aroma. In addition to all the roasting aromas, which thus arise and are of great significance for the flavor and the odor of the later coffee, however, carbon dioxide also develops.

This results in that the coffee beans “ripen” further even after the roasting process. This discharge of carbon dioxide certainly takes place in quantities which are not minor, because up to six liters of gas can thus still escape from the beans thereafter.

If the beans were poured directly after the roasting into airtight packages, the probability would thus be high that these packages would burst sooner or later. For this reason, the finished roasted beans are frequently firstly decanted into silos, in which they can “outgas”. Because the roasted beans lose more aroma the more time they pass in the air, depending on the preferences of the roaster, they are packed after a period of between two days and two weeks.

However, since at this point in time the process of outgassing is thus not yet fully completed, according to the prior art up to this point, a plastic valve is arranged in the package, which preserves the package from bursting by letting the arising roasting gases escape. With the aid of such a valve, the coffee can thus be safely packaged and delivered to the buyer with full flavor.

However, to save the cost for the valve, some producers introduce a hole into the package instead of such a valve, in order to ensure that the released gases of the roasted beans can escape. However, not only can carbon dioxide escape through the hole, but rather oxygen can also flow in. The packaged coffee thus ages significantly faster, however, and no longer contains its full aroma when it arrives at the customer.

### SUMMARY OF THE INVENTION

The object of the present invention is to disclose an alternative packaging option for outgassing and/or maturing foods, in particular for roasted coffee and/or coffee beans, by means of which the ripeness, in particular, the aroma of the relevant packaged product can be substantially maintained in the closed package and, in particular, can be produced in a more cost-effective and environmentally friendly manner. This is because less plastic has to be used, so that resources can be preserved.

Accordingly, a package for outgassing foods and/or maturing foods, in particular roasted coffee and/or coffee beans, comprising a bag for storing the food, which includes a film from which the bag is formed, wherein a valve is provided to enable a discharge of gas from the package bag to the outside in the event of overpressure in the package and to reduce the diffusion-related gas exchange in the case of comparable and/or equal pressure conditions in and/or outside the package bag, is distinguished in that the valve is formed as a microperforation in the film having at least one or two holes:
of the size of 750 μm² to 40 000 μm², preferably of 390 μm² to 20 000 μm², particularly, preferably 70 μm² to 16 000 μm², and/or
each having the diameter of 10-70 μm, preferably 20-60 μm, particularly preferably 30 μm.

This has the effect that gas does escape from the interior of the package, but oxygen cannot enter the interior of the package. That is to say, gases outgassing from the packaged product which is packaged can only accumulate in the package up to an internal pressure corresponding to the external ambient air pressure or lying slightly above it and can escape from it as soon as this internal gas pressure exceeds the flow resistance of the resistance resulting from the hole/the holes formed according to the present invention in the package film and the external pressure. Diffusion processes which could also promote the penetration of oxygen into the package advantageously play a rather minor role.

An intensification of the maturing process of the packaged product which is packaged in the relevant package is thus prevented, in particular, the aroma of roasted coffee beans can thus be protected and maintained for a long time.

According to one preferred embodiment, a package is designed so that no additional valve is provided except for the microperforation. That is to say, without a separately formed valve incorporated/welded into the package by means of a corresponding processing step which is additionally to be provided.

Due to the holes provided according to the present invention on the packages, the production, the storage/warehousing, and also the processing procedure for introducing such a valve, generally designed as a membrane valve, are dispensed with. The packaging material, which consists of a film, can thus also still remain very thin, since a conventional membrane valve as is known from the prior art is usually significantly thicker than the film material.

In particular, the film of the package can have a thickness of 20 μm to 200 μm, preferably of 40 μm-140 μm, so that optimum processing is possible.

The film of the package preferably comprises:
a paper layer and/or
a biofilm and/or
an aluminum layer and/or
a film having metallization and/or
a plastic and/or at least one plastic layer, in particular made of PET, PE and/or PP, PA and/or a biologically degradable film, wherein the film is formed, in particular, as a composite material. For example, a film made up of a composite material made of paper and plastic (for example, PE) or made up of a composite material made of paper and biofilm is also conceivable.

A biofilm is to be understood as a biologically degradable film and/or a bio-based plastic and/or an oxo-degradable plastic. Biologically degradable plastics can also be manufactured from renewable raw materials. Bio-based plastics are generally manufactured from renewable raw materials. Oxo-degradable plastics generally fragment rapidly after use, wherein metal ions, such as cobalt, manganese, iron, or the like are added to the polymers. The fragmentation takes place due to oxidation, using which the polymer chains can be degraded, triggered by UV light, heat, or the like, for example.

As a mechanical protection, according to a further preferred embodiment, the package can preferably have an edge reinforced by melting, in particular, by melting during the incorporation of the holes during the microperforation, around each of the holes.

It is thus possible to prevent the package from tearing at the holes upon the occurrence of stronger loads thereon and possibly the packaged product from being able to fall out of the package.

The package can thus also be designed so that the holes are arranged as desired on the package surface. If multiple holes are formed, they can also be arranged, for example, in the form of a logo and/or a trademark on the package surface.

The present invention also relates to a method for producing a package. This method is distinguished in that the microperforation is produced by a laser, in particular, a CO laser and/or a CO₂ laser.

The CO laser having a wavelength in the range of 5 μm (+/−1 μm) is particularly suitable for the method. It may be focused better by approximately a factor of 2 in comparison to the widespread CO₂ laser having a wavelength of 10.6 μm (+/−2 μm).

The laser beam is used via a lens having a focal length in the range of 25 mm to 150 mm, preferably 50 mm to 80 mm, and focused on the film web. To minimize the focus diameter, an expansion optical unit is preferably used in front of the lens. The greater the illumination of the lens is, the smaller the focus diameter can be.

The process preferably runs on an unwinder, doctor roller, or roller cutter with moving film web. To introduce the holes, the laser beam is focused via a lens on the film web. In pulsed operation, pulse times in the range of 50 μs to 500 μs, preferably 100 μs to 200 μs are selected at the laser.

A mirror deflection system is used to achieve very high web running speeds in the range of 200 m/min to 700 m/min. The focused laser beam is synchronized with the speed of the film web via this mirror deflection system during the pulse time/duration.

A further option for increasing the throughput is to split the laser beam by means of beam splitter optical units or diffractive optical units. A laser beam is split here into two or more laser beams and then focused onto the film web.

### BRIEF DESCRIPTION OF THE DRAWINGS

An exemplary embodiment is explained in greater detail hereinafter with reference to the appended figures.

FIG. 1 schematically shows by way of example a package, in particular, for roasted coffee and/or coffee beans, having a valve formed as a microperforation; and

FIG. 2 also schematically shows by way of example an enlarged illustration of a film of the package corresponding to the valve shown as a microperforation in FIG. 1.

### DETAILED DESCRIPTION OF THE INVENTION

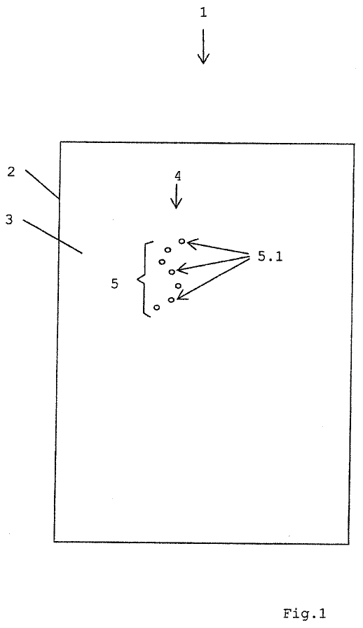

Accordingly, FIG. 1 schematically shows by way of example a package 1 for outgassing foods and/or maturing foods, in particular, roasted coffee and/or coffee beans. It comprises a bag 1 for storing the food, which includes a film 3 from which the bag is formed.

To discharge gas from the package bag to the outside, a valve 4 is provided, which is implemented as a microperforation 5 formed in the film 3. The microperforation 5 has 7 holes 5.1 shown here by way of example.

The size of the holes 5.1 is preferably in the range of 750 μm² to 40 000 μm², preferably of 390 μm² to 20 000 μm², particularly, preferably 70 μm² to 16 000 μm².

Their diameter is preferably in each case between 10-70 μm, preferably 20-60 μm, particularly, preferably 30 μm.

The holes 5.1 are shown arranged in the form of a “S” or other symbol or the like, in order to symbolize a logo or the like, for example.

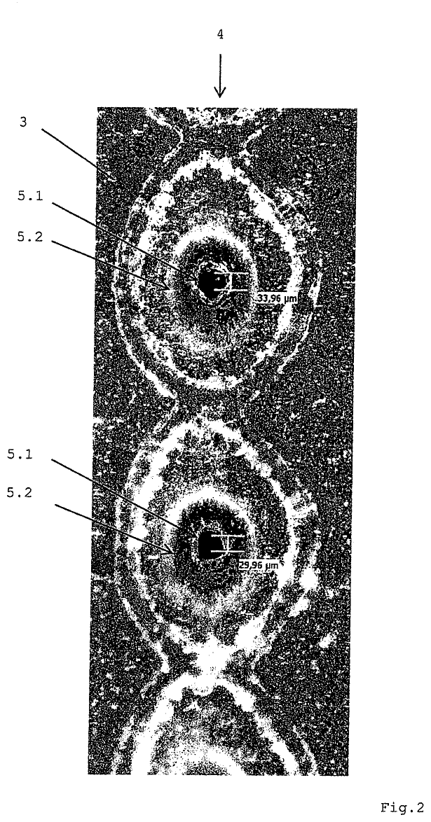

FIG. 2 schematically shows by way of example an enlarged illustration of a section of the film 3 of the package 1 corresponding to the valve 4 shown as the microperforation 5 in FIG. 1.

In contrast to FIG. 1, the holes 5.1 are arranged in a line by way of example. In principle, the holes 5.1 can also be arranged in any desired way on the package surface, however.

To increase the mechanical strength of the package 1, an edge 5.2 reinforced by melting, in particular, by melting during the incorporation of the holes in the microperforation, can be formed around each of the holes 5.1.

A melted edge is generally provided in principle. Depending on the material (for example, in the case of a composite material made of paper and biofilm), the melted edge can also be formed very narrow, however

According to the embodiment shown in the image of FIG. 2, this reinforced region 5.2 can extend significantly beyond the immediate surrounding edge of the relevant hole 5.1, for example, readily up to a region extending by up to five times or more of the hole diameter. A uniform force distribution around the hole edge into the film can be effectuated in this way, which massively counteracts tearing.

### LIST OF REFERENCE NUMERALS

1 package
2 bag
3 film
4 valve
5 microperforation
5.1 hole
5.2 edge

1. A package for outgassing food and/or maturing food, comprising a bag for storing the food, which includes a film from which the bag is formed, wherein a valve is provided to enable a discharge of gas from the package bag to the outside in the event of overpressure in the package and to reduce the diffusion-related gas exchange in the case of comparable and/or equal pressure conditions in and/or outside the package bag,
wherein the valve is formed as a microperforation in the film having at least one hole of a size of 750 μm² to 40 000 μm², and having a diameter of 10-70 μm.

2. The package according to claim 1, wherein no additional valve is provided except for the microperforation.

3. The package according to claim 1, wherein the film has a thickness of 20 μm to 200 μm.

4. The package according to claim 1, wherein the film comprises:
a paper layer and/or
a biofilm and/or
an aluminum layer and/or
a film having metallization and/or
a plastic and/or at least one plastic layer and/or a biologically degradable film,
wherein the film is formed in particular as a composite material.

5. The package according to claim 1, further comprising an edge reinforced by melting formed around the hole.

6. The package according to claim 1, wherein the at least one hole includes two holes arranged on the package surface.

7. A method for producing a package according to claim 1, wherein the microperforation is produced by a laser.

8. The package according to claim 1, wherein the food is roasted coffee or coffee beans.

9. The package according to claim 1, wherein the hole has a size of 390 μm² to 20,000 μm².

10. The package according to claim 1, wherein the hole has a diameter of 10-70 μm.

11. The package according to claim 3, wherein the film has a thickness of 40 μm to 140 μm.

12. The package according to claim 4, wherein the plastic is selected from PET, PE, PP and PA.

13. The package according to claim 4, wherein the biologically degradable film is a PLA layer.

14. The package according to claim 5, wherein the edge is formed by melting during the incorporation of the hole in the microperforation.

15. The method of claim 7, wherein the laser is a CO laser or a CO₂ laser.
